(19) United States
(12) Patent Application Publication
(10) Pub. No.: US 2013/0232275 A1
(43) Pub. Date: Sep. 5, 2013

(54) APPARATUS AND METHOD FOR ESTABLISHING CONNECTIONS

(71) Applicant: Ervin Beres, Budapest (HU)

(72) Inventor: Ervin Beres, Budapest (HU)

(73) Assignee: NOKIA SIEMENS NETWORKS OY, Espoo (FI)

(21) Appl. No.: 13/988,367

(22) PCT Filed: Dec. 1, 2010
(86) PCT No.: PCT/EP2010/068666

§ 371 Date: May 20, 2013

(51) Int. Cl. H04L 29/06

(52) U.S. Cl. CPC H04L 65/1069
USPC 709/228

(57) ABSTRACT

A mechanism for establishing connections is described. The mechanism comprises: sending a first message comprising the domain name of a network element to a server; receiving a response message comprising server record and domain names relevant to primary IP address and secondary IP address of the network element from the server; determining, on the basis of the received response message, the domain names relevant to the primary IP address and secondary IP address of the network element respectively; sending a second message comprising the determined domain name relevant to the primary IP address of the network element to the server; receiving the primary IP address of the network element from the server; attempting to establish a first connection towards the network element based on the obtained primary IP address; sending a third message comprising the determined domain name relevant to the secondary IP address of the network element to the server in the event that the first connection establishment attempt fails; receiving the secondary IP address of the network element from the server in response to the third message; and attempting to establish a second connection towards the network element based on the obtained secondary IP address.

### FIELD OF THE INVENTION

The invention addresses issues regarding establishing network connections between network elements, in particular, when multi-homing technology is being deployed in a network.

### BACKGROUND OF THE INVENTION

Multi-homing is a technique to increase the reliability of the Internet connection for an IP network. In such deployment, Stream Control Transmission Protocol (SCTP) is normally the ideal choice for transport layer protocol. The basic idea of multi-homing is that a network entity is equipped with a few physical interfaces and each of the physical interfaces is assigned with a different IP address as shown in FIG. 1. Among these IP addresses, one of the IP addresses may be assigned as “primary” IP address, the rest IP addresses may be called as “non-primary” or “secondary” IP addresses. In the exemplary example as shown in FIG. 1, each of the network elements, NE₂ (11) and NE₂ (12), has one “secondary” IP address. They may have more than one “secondary” IP addresses although it is not shown in the figure. In such a multi-homing arrangement, a network element always tries to utilize the connection based on “primary” IP address first. In case such connection fails, the network element would automatically turn to the connection established by using secondary IP address. As shown in FIG. 1, when a failure of an IP router (13) cuts the connection based on “primary” IP address between NE_{I} (11) and NE₂ (12), they will immediately switch to the backup connection established by using “secondary” IP address. In this way, multi-homing deployment provides significant resilience that would be otherwise difficult to achieve. A network element knows its own primary and secondary IP addresses. It is thus important to obtain the IP addresses of a destination network element and to know which one is primary and which one is secondary.

In a prior art solution as shown in FIG. 1, such information is obtained during the start-up. A network element NE₁ (11) will first send a query to a Domain Name System (DNS) server (15) to obtain a primary IP address of another network element NE₂ (12). Once the connection based on the primary IP address is established, the information regarding the secondary IP address of the other network element can be obtained via the established connection.

However, if the network connection based on primary IP address can not be established (due to some disruption in the network, for instance) during the start-up phase, it would be not able to use any secondary IP address to establish any network connection either because they are not known to the network element. Thus, the connection between NE₁ (11) and NE₂ (12) can not be established. The only remedy is to manually configure the IP addresses of NE₂ (12) in NE₁ (11). The IP addresses centrally stored in DNS can not be used. It is especially troublesome when these network elements are located in different administrative domains.

It is an object of the invention to provide a solution to overcome the above-mentioned problems.

### SUMMARY OF THE INVENTION

The present invention and its embodiments seek to address one or more of the above-described drawbacks and shortcomings.

According to an exemplary first aspect of the invention, there is provided a method for establishing connection. The method comprises sending a first message comprising the domain name of a network element to a server; receiving a response message comprising server record and domain names relevant to primary IP address and secondary IP address of the network element from the server; determining, on the basis of the received response message, the domain names relevant to the primary IP address and secondary IP address of the network element respectively; sending a second message comprising the determined domain name relevant to the primary IP address of the network element to the server; receiving the primary IP address of the network element from the server; attempting to establish a first connection towards the network element based on the obtained primary IP address; sending a third message comprising the determined domain name relevant to the secondary IP address of the network element to the server in the event that the first connection establishment attempt fails; receiving the secondary IP address of the network element from the server in response to the third message; and attempting to establish a second connection towards the network element based on the obtained secondary IP address.

According to further development or modification of the invention, the order of the domain names in said response message indicates the domain name relevant to the primary IP address. Alternatively, the domain name relevant to the primary IP address is indicated by a pre-defined domain name in said response message. Optionally, the domain name relevant to the primary IP address is indicated by a priority or/and a weight field of server record in said response message.

According to another aspect of the invention, there is provided a method (typically operated at a server). The method comprises receiving, from a first network element, a first message comprising a domain name of a second network element; retrieving, from a database of the server, domain names relevant to primary IP address and secondary IP address of the second network element; sending a response message comprising a server record, the retrieved domain names and an indication indicating the domain name relevant to the primary IP address to the first network element.

According to further development or modification of the invention, the order of the domain names in said response message indicates the domain name relevant to the primary IP address.

Alternatively, the domain name relevant to the primary IP address is indicated by a pre-defined domain name in said response message. Optionally, the domain name relevant to the primary IP address is indicated by a priority or/and a weight field of server record in said response message.

According to a third aspect of the invention, there is provided a network element comprising a processor, a first interface unit and a second interface unit. Said processor is configured to: send a first message comprising the domain name of a first network element to a server through said first interface unit; receive a response message comprising server record and domain names relevant to primary IP address and secondary IP address of the first network element from the server through said first interface unit; determine, on the basis of the received response message, the domain names relevant to the primary IP address and secondary IP address of the first network element respectively; send a second message comprising the domain name relevant to the primary IP address of the first network element to the server through said first interface unit; receive the primary IP address of the first network element from the server through said first interface unit; attempt to establish a first connection towards the first network element based on the obtained primary IP address through said first interface unit; send a third message comprising the domain name relevant to the secondary IP address of the first network element to the server through said second interface unit in the event that the first connection establishment attempt fails; receive the secondary IP address of the first network element from the server through said second interface unit in response to the third message; and attempt to establish a second connection towards the first network element based on the obtained secondary IP address through said second interface unit.

According to one embodiment of the invention, the order of the domain names in said response message indicates the domain name relevant to the primary IP address.

Alternatively, the domain name relevant to the primary IP address is indicated by a pre-defined domain name.

Optionally, the domain name relevant to the primary IP address is indicated by a priority or/and a weight field of server record in said response message.

According to a fourth aspect of the invention, there is provided a server comprising a processor, an interface unit and a database. Said processor is configured to: receive, from a first network element, a first message comprising a domain name of a second network element through said interface unit; retrieve, from said database, domain names relevant to primary IP address and secondary IP address of the second network element; and send a response message comprising server record, the retrieved domain names and an indication indicating the domain name relevant to the primary IP address to the first network element through said interface unit.

According to another embodiment of the invention, the order of the domain names in said response message indicates the domain name relevant to the primary IP address.

Alternatively, the domain name relevant to the primary IP address is indicated by a pre-defined domain name in said response message. Optionally, the domain name relevant to the primary IP address is indicated by a priority or/and a weight field of server record in said response message.

According to a fifth aspect of the invention, there is provided a computer program. The computer program comprises: code (or other means) for sending a first message comprising the domain name of a network element to a server; code (or other means) for receiving a response message comprising server record and domain names relevant to primary IP address and secondary IP address of the network element from the server; code (or other means) for determining, on the basis of the received response message, the domain names relevant to the primary IP address and secondary IP address of the network element respectively; code (or other means) for sending a second message comprising the determined domain name relevant to the primary IP address of the network element to the server; code (or other means) for receiving the primary IP address of the network element from the server; code (or other means) for attempting to establish a first connection towards the network element based on the obtained primary IP address; code (or other means) for sending a third message comprising the determined domain name relevant to the secondary IP address of the network element to the server in the event that the first connection establishment attempt fails; code (or other means) for receiving the secondary IP address of the network element from the server in response to the third message; code (or other means) for attempting to establish a second connection towards the network element based on the obtained secondary IP address. The computer program may be a computer program product comprising a computer-readable medium bearing computer program code embodied therein for use with a computer.

According to a sixth aspect of the invention, there is provided a computer program (for a server). The computer program comprises: code (or other means) for receiving, from a first network element, a first message comprising a domain name of a second network element; code (or other means) for retrieving, from a database of the server, domain names relevant to primary IP address and secondary IP address of the second network element; code (or other means) for sending a response message comprising server record, the retrieved domain names and an indication indicating the domain name relevant to the primary IP address to the first network element. The computer program may be a computer program product comprising a computer-readable medium bearing computer program code embodied therein for use with a computer.

### BRIEF DESCRIPTION OF THE DRAWINGS

Exemplary embodiments of the invention are described below, by way of example only, with reference to the following numbered drawings.

FIG. 1 is an exemplary example illustrating multi-homing deployment in an IP network.

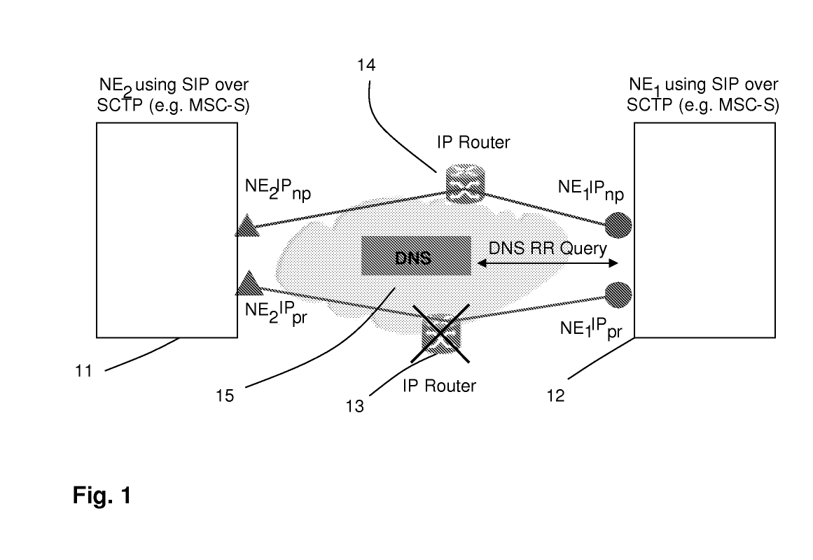

FIG. 2 shows another example of multi-homing deployment in an IP network.

FIG. 3 depicts message flow between a DNS (Domain Name Server) and one network element (NE3) according to one embodiment of the invention.

FIG. 4 shows a schematic block diagram illustrating a DNS, according to some embodiments of the invention.

FIG. 5 shows a schematic block diagram illustrating a network element, according to some embodiments of the invention.

### DESCRIPTION OF THE EMBODIMENTS OF THE INVENTION

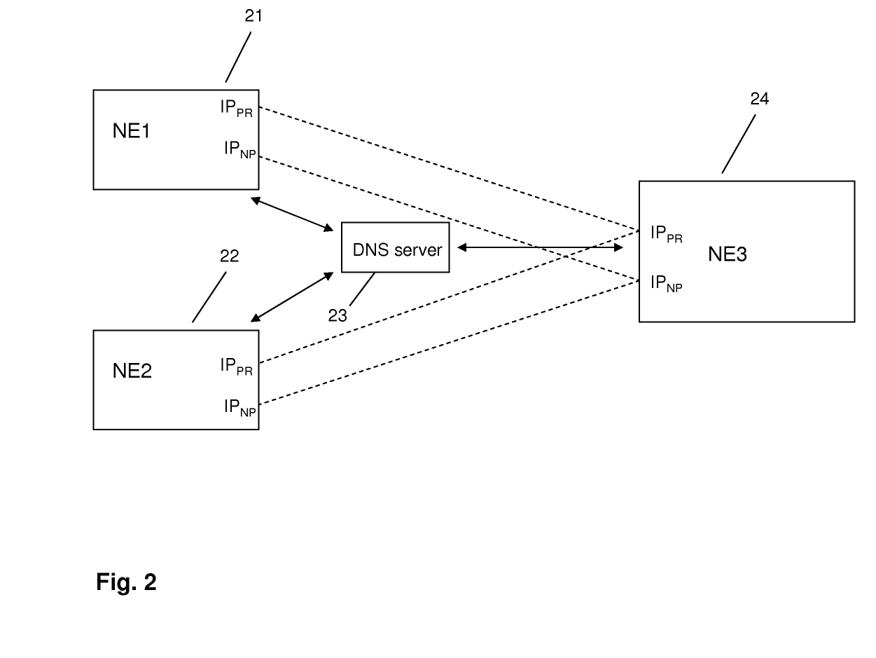

FIG. 2 depicts another arrangement of multi-homing arrangement, where a network element (NE3) is connected with other two network elements (NE1 & NE2). As a general rule of multi-homing concept, the primary IP address in a network element (e.g. NE3) shall be connected to its counterpart in another network element (e.g. NE1 or NE2). The non-primary IP address of the network elements shall be connected accordingly. As stated previously, a network element knows its own primary and non-primary IP address. If it (e.g. NE3) attempts to establish a connection to another network element (e.g. NE2), it may first contact a DNS (23) to request, for example, the primary IP address of NE2 (22). Likewise, if NE1 (21) or NE2 (22) wants to initiate a connection towards NE3 (24), they may contact the DNS (23) to request, for example, the primary IP address of NE3 (24).

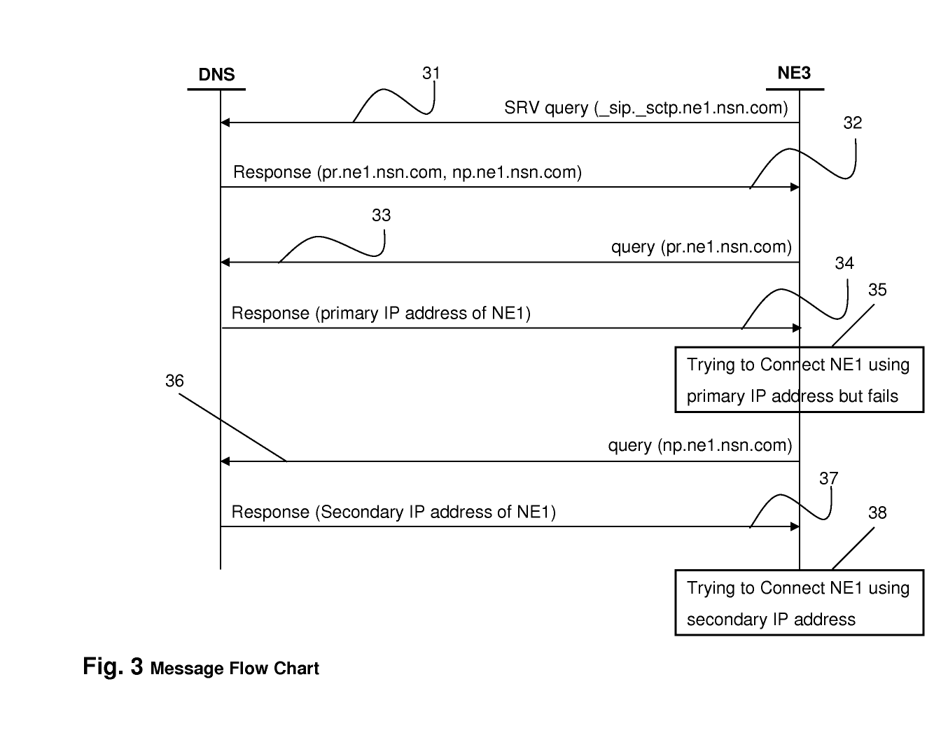

FIG. 3 describes the message flow between a DNS and a network element (NE3) according to embodiments of the invention.

As explained previously, before attempting to establish a connection towards another network element, e.g. NE1, NE3 may request relevant IP addresses of NE1 from a server, e.g. a DNS. In step 31, NE3 may send a server record query (SRV, defined in IETF RFC2782) message comprising the domain name of NE1 to the DNS. “_sip” and “_sctp” indicate the underlying protocols being used for sending the query. Although Session Initiation Protocol (SIP) and Stream Control Transmission Protocol (SCTP) are the preferred protocols in the arrangement, any other suitable protocols may also be used instead. Upon receiving the message, DNS may response with a message comprising the domain names relevant to the primary and secondary IP addresses of NE1 as shown in step 32.

The response message may also indicate which domain name is relevant to primary IP address and which one is relevant to secondary IP address. According to one embodiment, the order of the domain names in the response message may indicate so, for example, the first/last domain name in the response message is always the one for primary IP address. As the domain name is normally contained a SRV record as part of the message, the priority field or/and the weight field of the SRV record may also be used to indicate which domain name is relevant to primary IP address according to another embodiment of the invention. A pre-defined domain name, for instance, pr.nel.nsn.com, may be used to specifically indicate the domain name relevant to primary IP address as well.

Alternatively, two response messages may be sent from the DNS to NE3 although it is not shown in FIG. 3. One response message may comprise the domain name relevant to the primary IP address of NE1 and another may comprise the domain name relevant to the secondary IP address of NE1. The order of sending the response messages may indicate the domain name relevant to the primary IP address. For example, the first or second message received by NE3 may comprise the domain name relevant to the primary IP address. The priority field or/and the weight field of the SRV record in the messages may also be used to indicate the domain name relevant to the primary IP address.

Based on the pre-defined rules as mentioned above, NE3 may determine the domain name relevant to the primary IP address of NE1. Then NE3 may send another query message comprising the determined domain name relevant to the primary IP address of NE1 to DNS as described in step 33. The DNS may then provide the primary IP address of NE1 to NE3 as shown in step 34. NE3 may try to establish a connection to NE1 by using the primary IP address. If the attempt fails as illustrated in step 35, NE3 may send a third query message comprising the domain name relevant to the secondary IP address of NE1 to DNS (step 36). In step 37, the DNS may provide the secondary IP address to NE3, which may be used by NE3 to initiate another attempt to establish connection to NE1 in step 38.

The above described message flow typically happens during start-up phase according to one aspect of the invention. However, it may be applicable in any other suitable situations.

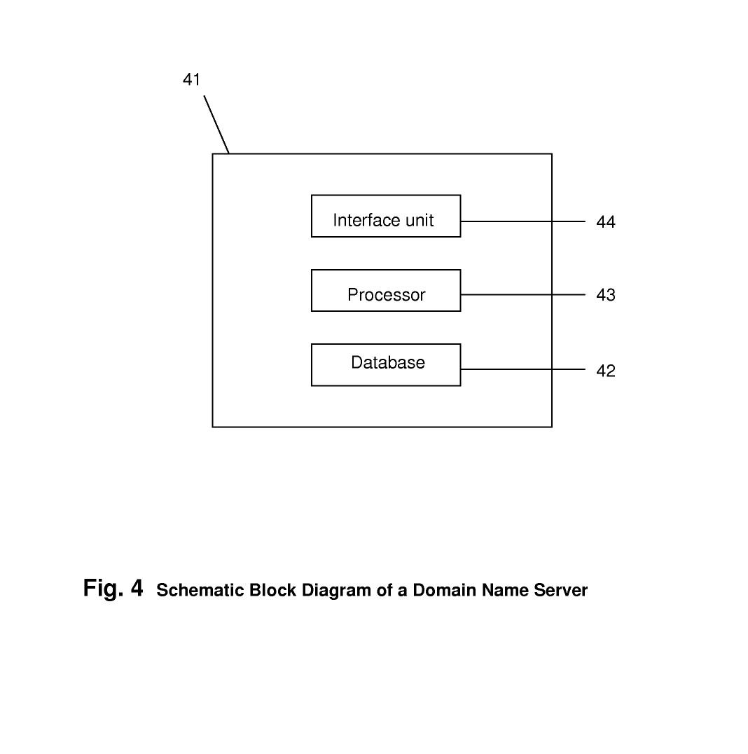

FIG. 4 describes a schematic block diagram illustrating a DNS (41) according to one embodiment of the invention. An interface unit (44) of the DNS may be used to receive message (e.g. a query) from a message sender or/and to send a response message to the message sender. The DNS may further comprise a database storing IP addresses or/and domain names of one or more network elements. Upon receiving a SRV query message (e.g. the message of step 31 in FIG. 3), the processor (or processing means) (43) of the DNS (41) may retrieve the database (42) to find the domain names relevant to the primary and secondary IP addresses of a network element, e.g. NE1 (i.e. pr.nel.nsn.com, np.nel.nsn.com). The DNS may send one response message comprising the domain names relevant to the primary and secondary IP addresses to the sender initiated the query.

The response message may also indicate which domain name is relevant to primary IP address and which one is relevant to secondary IP address. According to one embodiment, the order of the domain names in the response message may indicate so, for example, the first/last domain name in the response message is always the one for primary IP address. As the domain name is normally contained a SRV record as part of the message, the priority field or/and the weight field of the SRV record may also be used to indicate which domain name is relevant to primary IP address according to another embodiment of the invention. A pre-defined domain name, for instance, pr.nel.nsn.com, may be used to specifically indicate the domain name relevant to primary IP address as well.

Alternatively, the DNS may send two response messages. One response message may comprise the domain name relevant to the primary IP address of NE1 and another may comprise the domain name relevant to the secondary IP address of NE1. The order of sending the response messages may indicate the domain name relevant to the primary IP address. For example, the first or second message received by NE3 may comprise the domain name relevant to the primary IP address. The priority field or/and the weight field of the SRV record in the messages may also be used to indicate the domain name relevant to the primary IP address.

Through the interface unit (44), the DNS (41) may receive another query comprising the domain name relevant to the primary/secondary IP address of a network element, e.g. NE1. The processor (43) may retrieve its database (42) to find the primary/secondary IP address of NE1 and send it back to the sender via the interface unit (44).

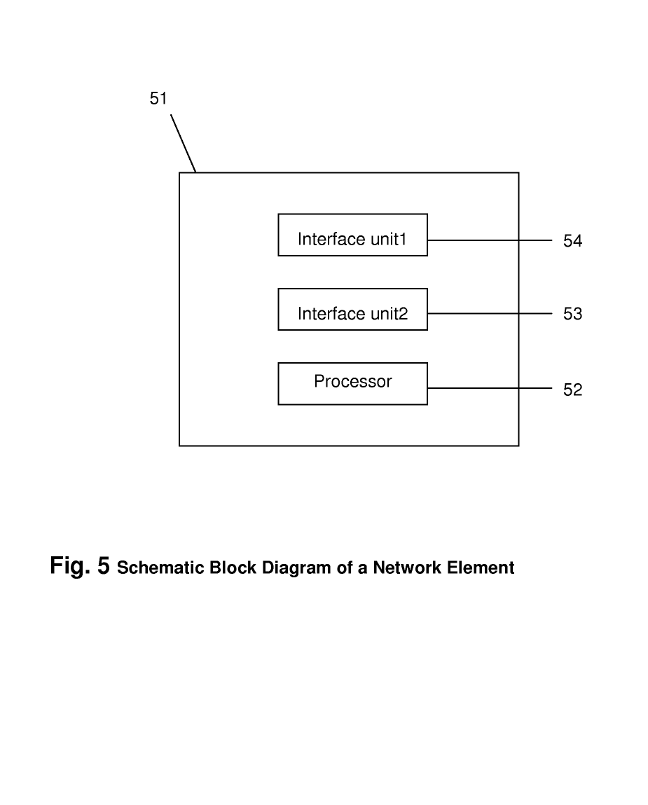

FIG. 5 describes a schematic block diagram illustrating a network element (51) according to one embodiment of the invention. Said network element may comprise two interface units (53, 54), one of them may be configured to be used for connection based on primary IP address, another may be used for connection based on secondary IP address. For instance, assuming interface unit 1 (54) is used for primary connection. Typically during start-up phase, the processor (or processing means) (52) of the network element (51) may send a query message to a server, for example a DNS, through interface unit 1 (54). The message may comprise domain name (e.g. nel.nsn.com) of another network element (e.g. called NE1) it wishes to connect. Said network element may receive a response message from the DNS and the response message may comprise the domain names relevant to the primary and secondary IP addresses of NE1 (e.g. pr.nel.nsn.com, np.nel.nsn.com).

The response message may also indicate which domain name is relevant to primary IP address and which one is relevant to secondary IP address. According to one embodiment, the order of the domain names in the response message may indicate so, for example, the first/last domain name in the response message is always the one for primary IP address. As the domain name is normally contained a SRV record as part of the message, the priority field or/and the weight field of the SRV record may also be used to indicate which domain name is relevant to primary IP address according to another embodiment of the invention. A pre-defined domain name, for instance, pr.nel.nsn.com, may be used to specifically indicate the domain name relevant to primary IP address as well.

Alternatively, said network element may receive two response messages from the DNS. One response message may comprise the domain name relevant to the primary IP address of NE1 and another may comprise the domain name relevant to the secondary IP address of NE1. The order of receiving the response messages may indicate the domain name relevant to the primary IP address. For example, the first or second message received by NE3 may comprise the domain name relevant to the primary IP address. The priority field or/and the weight field of the SRV record in the messages may also be used to indicate the domain name relevant to the primary IP address.

After determining the domain name relevant to the primary IP address of NE1 based on the predefined rules as discussed above, the processor (or processing means) (52) of said network element (51) may send another query to the DNS through interface unit 1 (54). The query may comprise the domain name relevant to the primary IP address of NE1. The network element (51) may receive, from the DNS, a response message comprising the primary IP address of NE1. The processor (52) of said network element (51) may attempt to connect NE1 by using the primary IP address. If it is successful, the connection is established. If not, the processor (52) of said network element (51) may send a third query to the DNS through interface unit 2 (53). The query may comprise the domain name relevant to the secondary IP address of NE1. The network element (51) may, from the DNS, receive a response comprising the secondary IP address of NE1 via interface unit 2 (53). The processor (52) may initiate a second attempt to connect NE1 by using the secondary IP address.

For the purpose of the present invention as described above, it should be noted that
method steps likely to be implemented as software code portions and being run using a processor at one of the server entities are software code independent and can be specified using any known or future developed programming language;
method steps and/or devices likely to be implemented as hardware components at one of the server entities are hardware independent and can be implemented using any known or future developed hardware technology or any hybrids of these, such as MOS, CMOS, BiCMOS, ECL, TTL, etc, using for example ASIC components or DSP components, as an example;
generally, any method step is suitable to be implemented as software or by hardware without changing the idea of the present invention;
devices can be implemented as individual devices, but this does not exclude that they are implemented in a distributed fashion throughout the system, as long as the functionality of the device is preserved.

It is to be understood that the above description is illustrative of the invention and is not to be construed as limiting the invention. Various modifications and applications may occur to those skilled in the art without departing from the scope of the invention as defined by the appended claims.

1. A method for establishing connection comprising
sending a first message comprising the domain name of a network element to a server,
receiving a response message comprising server record and domain names relevant to primary IP address and secondary IP address of the network element from the server,
determining, on the basis of the received response message, the domain names relevant to the primary IP address and secondary IP address of the network element respectively,
sending a second message comprising the determined domain name relevant to the primary IP address of the network element to the server,
receiving the primary IP address of the network element from the server,
attempting to establish a first connection towards the network element based on the obtained primary IP address,
sending a third message comprising the determined domain name relevant to the secondary IP address of the network element to the server in the event that the first connection establishment attempt fails,
receiving the secondary IP address of the network element from the server in response to the third message, and
attempting to establish a second connection towards the network element based on the obtained secondary IP address.

2. The method according to claim 1, wherein the order of the domain names in the response message indicates the domain name relevant to the primary IP address.

3. The method according to claim 1, wherein the domain name relevant to the primary IP address is indicated by a pre-defined domain name.

4. The method according claim 1, wherein the domain name relevant to the primary IP address is indicated by a priority or/and a weight field of server record in the response message.

5. A method comprising
receiving, from a first network element, a first message comprising a domain name of a second network element,
retrieving, from a database of the server, domain names relevant to primary IP address and secondary IP address of the second network element,
sending a response message comprising a server record, the retrieved domain names and an indication indicating the domain name relevant to the primary IP address to the first network element.

6. The method according to claim 5, wherein the order of the domain names in the response message indicates the domain name relevant to the primary IP address.

7. The method according to claim 5, wherein the domain name relevant to the primary IP address is indicated by a pre-defined domain name.

8. The method according claim 5, wherein the domain name relevant to the primary IP address is indicated by a priority or/and a weight field of server record in the response message.

9. A network element comprising a processor, a first interface unit and a second interface unit, wherein, said processor is configured to:
send a first message comprising the domain name of a first network element to a server through the first interface unit,
receive a response message comprising server record and domain names relevant to primary IP address and secondary IP address of the first network element from the server through the first interface unit,
determine, on the basis of the received response message, the domain names relevant to the primary IP address and secondary IP address of the first network element respectively,
send a second message comprising the domain name relevant to the primary IP address of the first network element to the server through the first interface unit,
receive the primary IP address of the first network element from the server through the first interface unit,
attempt to establish a first connection towards the first network element based on the obtained primary IP address through the first interface unit,
send a third message comprising the domain name relevant to the secondary IP address of the first network element to the server through the second interface unit in the event that the first connection establishment attempt fails,
receive the secondary IP address of the first network element from the server through the second interface unit in response to the third message, and
attempt to establish a second connection towards the first network element based on the obtained secondary IP address through the second interface unit.

10. The network element according to claim 9, wherein the order of the domain names in the response message indicates the domain name relevant to the primary IP address.

11. The network element according to claim 9, wherein the domain name relevant to the primary IP address is indicated by a pre-defined domain name.

12. The network element according claim 9, wherein the domain name relevant to the primary IP address is indicated by a priority or/and a weight field of server record in the response message.

13. A server comprising a processor, an interface unit and a database, wherein, said processor is configured to:
receive, from a first network element, a first message comprising a domain name of a second network element through said interface unit,
retrieve, from said database, domain names relevant to primary IP address and secondary IP address of the second network element, and
send a response message comprising server record, the retrieved domain names and an indication indicating the domain name relevant to the primary IP address to the first network element through said interface unit.

14. The server according to claim 13, wherein the order of the domain names in the response message indicates the domain name relevant to the primary IP address.

15. The server according to claim 13, wherein the domain name relevant to the primary IP address is indicated by a pre-defined domain name.

16. The server according claim 13, wherein the domain name relevant to the primary IP address is indicated by a priority or/and a weight field of server record in the response message.

17. A computer program product comprising:
means for sending a first message comprising the domain name of a network element to a server,
means for receiving a response message comprising server record and domain names relevant to primary IP address and secondary IP address of the network element from the server,
means for determining, on the basis of the received response message, the domain names relevant to the primary IP address and secondary IP address of the network element respectively,
means for sending a second message comprising the determined domain name relevant to the primary IP address of the network element to the server,
means for receiving the primary IP address of the network element from the server,
means for attempting to establish a first connection towards the network element based on the obtained primary IP address,
means for sending a third message comprising the determined domain name relevant to the secondary IP address of the network element to the server in the event that the first connection establishment attempt fails,
means for receiving the secondary IP address of the network element from the server in response to the third message,
means for attempting to establish a second connection towards the network element based on the obtained secondary IP address.

18. A computer program product comprising:
means for receiving, from a first network element, a first message comprising a domain name of a second network element,
means for retrieving, from a database of the server, domain names relevant to primary IP address and secondary IP address of the second network element,
means for sending a response message comprising server record, the retrieved domain names and an indication indicating the domain name relevant to the primary IP address to the first network element.
